(19) United States
(12) Patent Application Publication
(10) Pub. No.: US 2007/0176156 A1
(43) Pub. Date: Aug. 2, 2007

(54) Fire retardant composition with insecticide

(75) Inventors: Michael John Mabey, Sherwood Park (CA); William Kish, Wadsworth, OH (US)

Correspondence Address: CHRISTOPHER JOHN RUDY, 209 HURON AVENUE, SUITE 8, PORT HURON, MI, 48060, US

(73) Assignee: No-Burn Investments, LLC, Wadsworth, OH (US)

(21) Appl. No.: 11/654,486

(22) Filed: Jan. 17, 2007

Related U.S. Application Data
(60) Provisional application No. 60/764,494, filed on Feb. 2, 2006.

(51) Int. Cl. C09K 21/00

(52) U.S. Cl. 252/601; 106/15.05

(57) ABSTRACT

Fire retardant composition has an insecticide. It can include a fire suppressing salt with insecticide. It can comprise a mixture of a substantially neutral ammonium phosphate salt in combination with an active hydrogen-containing nitrogenous organic compound, and a hydroxyl-containing carbonific, plus the insecticide. The composition may further include another active agent, for example, a mold inhibitor. The insecticide may be, for example, a termiticide.

This claims benefits under 35 USC 119(e) of application No. U.S. 60/764,494 filed on Feb. 2, 2006 A.D. The specification of that application is incorporated herein by reference.

### FIELD AND PURVIEW OF THE INVENTION

In general, the invention concerns a fire retardant composition with an insecticide, optionally with a mold inhibitor, and methods to make and use it, and a substrate combined with the composition or residue thereof. For instance, the present composition can have a first fire retardant agent of an ammonium phosphate substance, plus a carbonific, for example, glucose or pentaerythritol, and a nitrogenous spumific, for example, urea, which are combined with the insecticide, notably which can function as a termiticide, and optionally the mold inhibitor, which can be, say, a quaternary organic halide. A generally clear, aqueous liquid may be formed.

### BACKGROUND TO THE INVENTION

Various fire retardants are known. Compositions are known that typically contain fire suppressing salts such as an ammonium phosphate or ammonium sulphate for aerial applications to combat forest fires. See, e.g., U.S. Pat. Nos. 3,196,108; 3,257,316; 3,309,324; 3,634,234; 3,730,890; 3,960,735; 4,447,336; 4,447,337; 4,606,831; 4,822,524; 4,839,065; 4,983,326 and 6,162,375. Others are known to have fire suppressants such as carbonaceous matter, organic phosphorous compounds, organic halides, or borates. See, e.g., U.S. Pat. Nos. 4,668,710; 4,686,241; 5,246,652; 5,968,669; 6,001,285; 6,025,027; 6,084,008 and 6,130,267.

In address of fire as a problem, especially in the modem home, which has many highly flammable, petroleum-based materials, conventional intumescent systems have been developed. They typically include as essential components: (1) an acid-forming substance, which may be referred to as a “catalyst”; (2) an expanding agent, which causes formation of a foamed (intumescent) layer by emission of an inert or non-combustible gas, which agent may be referred to as a “spumific”; and (3) a binder such as a thermoplastic resin, which contributes to the film-forming properties of the system and provides a portion of a char skeleton, and which is usually referred to as a “carbonific.” A component may have more than one function. Such phosphate-catalyzed intumescent compositions can be made of components selected from the following:
1. As the acid source (catalyst), usually amino phosphates, mainly ammonium polyphosphates, ammonium orthophosphate, and melamine phosphate, say, in an amount of about 25% by weight of the total formulation.
2. As the spumific, melamine, melamine salts, melamine derivatives, urea and/or dicyandiamide.
3. As the carbonific, a polyhydroxy compound, usually a polyol, which is decomposed by liberated phosphoric acid to form an ester that results in formation of the char (carbonification), for example, pentaerythritol, dipentaerythritol, tripentaerythritol, or certain sugars, starches or starch derivatives.
   Such conventional systems are known to be opaque since compounds such as ammonium polyphosphate in powder form, powdered amines and carbonific components are often employed. As well, these tend to be expensive.

In address of the foregoing, Mabey, U.S. Pat. No. 6,989,113, disclosed a fire retardant. A commercial embodiment covered by the '113 patent is NO-BURN® WOOD GARD™ product, which is available from NO-BURN, INC.

Another problem of serious concern is damage from mold, especially toxic black mold (Stachybotrys chartarum). In improving the art, especially that of the application leading to the Mabey '113 patent, Mabey et al., U.S. Pat. No. 6,982,049, disclosed a fire retardant with mold inhibitor. A commercial embodiment covered by the '049 patent is NO-BURN® WOOD GARD™ MIH™ product, which is also available from NO-BURN, INC.

Compare, U.S. patent application Pub. Nos. 2005/0138888 and 2005/0022466.

Insect damage to building structures, including homes, notably, for example, from termites, especially in warmer climates, is also a problem of concern. In address of this, various insect- and termite-protection products are also known. Note, U.S. Pat. No. 6,896,908, which discloses a wood-preservative concentrate of a leach-resistant borate for lignocellulosic-based products to provide resistance against insect and fungal attack; and U.S. Pat. Nos. 6,894,074 and 6,716,874, which disclose synergistic insecticidal mixtures.

It would be desirable to further improve upon the art.

### SOME OBJECTS OF THE INVENTION

It is a general object to improve upon the art.

It is a particular object to provide protection from insect and so forth pests, and notably termites, to a fire retardant composition. It is a further particular object to do the same with fire retardant compositions that have other capabilities such as stain-protection and/or mold-inhibition, especially the latter. It is a special object to provide the same with an ammonium phosphate type fire retardant formulation, with or without mold inhibitor, notably such as disclosed by the Mabey '113 and Mabey et al. '049 patents, especially with the mold inhibitor, particularly for control of Stachybotrys chartarum, for example, with the NO-BURN® WOOD GARD™ or NO-BURN® WOOD GARD™ MIH™ products, while retaining desirable properties of the composition. It is an especially desirable object to provide for control of termite infestation and feeding, on and through the surface of a material coated with the fire retardant composition.

The present invention satisfies at least one if not more or even all of these and other objects, if not wholly at least in part.

### FULL DISCLOSURE OF THE INVENTION

In general, the present invention provides, in one aspect, a fire retardant composition having an insecticide, which in one general embodiment can include a fire suppressing salt with insecticide, which in a more particular embodiment can include a phosphate-catalyzed intumescent composition with an acid source, a spumific and a carbonific, plus insecticide, which in an even more particular embodiment can include an ammonium phosphate containing fire retardant with insecticide, and which in a more preferred embodiment can comprise a mixture of a substantially neutral ammonium phosphate salt in combination with an active hydrogen-containing nitrogenous organic compound, and a hydroxyl-containing carbonific, plus the insecticide. The composition may further include another active agent, for example, a mold inhibitor. The insecticide may be, for example, a termiticide. Such a composition can be made by contacting a phosphoric acid with ammonia to form the ammonium phosphate, contacting the ammonium phosphate with the active hydrogen-containing nitrogenous organic compound, the hydroxyl-containing carbonific, and the insecticide, optionally the mold inhibitor, under conditions sufficient to form the composition. The composition can be used by contacting it with a substrate, which advantageously is otherwise flammable, under conditions sufficient to be flame retardant and provide for the kill, control or repellence of a target invertebrate, optionally to be also mold inhibitory. Another aspect is an article of manufacture comprising, in combination, the substrate, and the present composition or a residue whereof.

The invention is useful in protecting building structures, their contents and/or their occupants, in general, from fire, insect damage or annoyance, optionally mold, and so forth.

Significantly, by the invention, the art is advanced in kind as an effective, cost-efficient, aesthetically pleasing fire retardant providing protection from insects, notably termites, is provided. Other active agents beneficially can provide protection from mold, notably Stachybotrys chartarum. For instance, flammable construction stock such as wooden board stock can be provided with good fire retardant ratings and effective termite and mold control; application of the composition is simple and easy; and a clear formulation can be provided to highlight the beauty of natural woodwork. A particular embodiment provides for control of termites and toxic black mold in a fire retardant. Addition of the insecticide adds notable value to the fire retardant and fire retardant with mold inhibitor. The composition of the invention can advantageously be applied directly to a wide range of materials, including wood, plywood, oriented strand board and chip board sheathing, paper, corrugated board materials, and so forth and the like. It is efficient and, with suitable precautions taken, reasonably safe to manufacture, store, transport and use. One of the many advantages of the present composition is that, since it can be applied directly to building materials before or on site, it greatly reduces financial and environmental costs in new structures of rendering materials fire retardant and termite resistant. Building materials may be rendered fire retardant and termite-repellant after construction by application of the composition. The composition may be considered to be an intumescent fire retardant, which has insecticidal, optionally mold inhibition, properties. Certain embodiments may be considered improvements in kind to the Mabey '113 and Mabey et al. '049 patents and to the excellent, commercially available NO-BURN® WOOD GARD™ and NO-BURN® WOOD GARD™ MIH™ products.

Numerous further advantages attend the invention.

The invention can be further understood by the additional detail set forth below. The same, like that set forth above, is to be taken in an illustrative and not necessarily limiting sense. Broadly, the invention combines a fire retardant with an insecticide. A mold inhibitor or other active agent may be provided as well.

A foundation of preferred embodiments of the invention is that a clear or substantially clear fire retardant base with or without mold inhibitor or other active agent can be prepared, and during or after its preparation can be added the insecticide. For instance, the base can be made by reacting phosphoric acid with ammonium hydroxide in a stoichometric ratio sufficient to make an aqueous solution of substantially neutral pH, which includes monoammonium and diammonium phosphates, in an exothermic reaction; the resultant solution, which is an example of an essentially or substantially neutral ammonium phosphate salt, next can be contacted or combined, perhaps reacted, with an active hydrogen-containing nitrogenous organic compound such as urea, and also with a hydroxyl-containing carbonific such as glucose or pentaerythritol to produce a typically viscous fire retardant solution. To the fire retardant base, a precursor stage thereof, or to a fire retardant with insecticide may be added the mold inhibitor or other active agent. It may be advantageous to add the insecticide and/or mold inhibitor or other active agent to the viscous fire retardant base solution promptly or immediately upon its manufacture.

Accordingly, the composition of the invention may be considered, in certain embodiments, to be a substantially if not essentially neutral ammonium phosphate salt in a matrix of a urea and a hydroxyl-containing carbonific, which has the insecticide, with or without mold inhibitor. The composition can form a coating and typically dries on the substrate.

The term, “fire retardant,” is a composition that, when applied to a flammable material, provides thermal protection for the material. In general, this may be done by reducing or perhaps even eliminating the tendency of the material to bum and/or by reducing the rate of flame spread along the surface of the material. Preferably, use of the fire retardant composition, for example, on a solid material such as wood substrate, reduces surface burning characteristics significantly, say, at least about 10%, at least about 25%, or at least about 50%, when compared to corresponding but untreated material, as tested by an appropriate test. For example, the test may be the ASTM E84 Steiner Tunnel Test. Without being bound by any theory, the preferred fire retardant composition of the present invention, based in general on the '958 Mabey fire retardant, is believed to operate generally as follows: The fire retardant composition decomposes under the heat of the fire to produce a nonflammable gas as well as a light weight char, which occurs at a lower temperature than the item on which it is applied would release flammable gases. The char formed as the ammonium phosphate breaks down, releasing ammonia gas, which leads to reaction of the phosphate with the carbon-bearing compounds to form a nonflammable ester. As the nitrogen-containing compounds break down to release non-flammable gas, the gas becomes trapped in the carbon mass, tending to puff it up, forming a char pillow. The char pillow, by reducing air flow, and hence, oxygen, and by reducing or blocking heat-transfer to the surface, tends to reduce the burning-propensity of the treated surface. As a result, fire is robbed of fuel and oxygen, generates less heat and smoke, and may in some circumstances extinguish itself.

The term, “insecticide,” is an agent that can kill, control and/or repel a target invertebrate. The target invertebrate can be an insect per se, for example, a termite, a carpenter, sweet or grease eating ant, a bee, hornet or wasp, a roach, a fly, a mosquito, a cricket, an earwig, a silverfish, a tick, a flea, a beetle, and so forth; another arthropod such as a spider, a centipede, and so forth; and/or a worm or even a snail or slug, and so forth. Target invertebrates considered building pests, which could include the termites, ants, bees, hornets and wasps, roaches, crickets, earwigs, silverfish, fleas, beetles, and spiders, especially termites, desirably are killed, controlled and/or repelled hereby. A specific target invertebrate may be under focus. Thus, for example, when the target invertebrate is a termite, the insecticide may be termed a “termiticide.”

The term, “mold inhibitor,” is an agent that can kill, control, or prevent growth of mold, mildew, or fungus, and so forth and the like flora, especially when formulated with a basic fire retardant composition with insecticide. A mold inhibitor may be fire retardant or fire accelerative, but, in the latter case, does not accelerate fire to a degree that the overall composition which contains the mold inhibitor cannot be considered to be a fire retardant composition. Preferably, however, use of the fire retardant composition with insecticide with mold inhibitor, for example, on a solid material as the substrate, reduces growth of the flora of interest significantly, say, at least about 60%, at least about 85%, or at least about 99% or even at least about 99.9%, if it does not kill it outright, for a significant time, say, at least about thirty days, at least about six months, or at least about 360 days or a year, if not, in effect, indefinitely, as tested by appropriate test methodology. For example, the test method may be by ASTM D5590-94, Determination of Resistance of a Coating Material to Fungal Growth.

In various general embodiments, any suitable fire retardant, which can be considered a basic or base fire retardant component, can have added to it the insecticide, optionally the mold inhibitor, which may be added at any suitable time(s) during manufacture. More particularly, a base fire retardant component may contain a fire suppressing salt such as an ammonium phosphate or ammonium sulphate, preferably the former. Even more particularly, the base fire retardant component may contain a phosphate-catalyzed intumescent composition with an acid source, a spumific and a carbonific. Desirably, however, the base fire retardant component includes the substantially neutral ammonium phosphate salt with a carbonific and spumific.

As the substantially neutral ammonium phosphate salt, any suitable ammonium phosphate, to include ammonium polyphosphates, and mixtures thereof, may be employed. Preferably, however, the substantially neutral ammonium phosphate salt is a mixture, which contains monoammonium and diammonium phosphates. The salt may be employed per se, or in conjunction with a diluent. Preferably, a diluent is employed, and, advantageously, the diluent acts as a solvent. Beneficially, the diluent is evaporative, which is to say that it can evaporate in the final product, leaving the fire retardant composition with mold inhibitor, or a residue thereof, with the substrate to which it applied, typically in a film type coating. As such, the diluent acts as a carrier. The diluent can be any suitable substance, including a hydroxyl-containing liquid such as an alcohol, water, or mixture thereof. Water is preferred. In one advantageous embodiment, the substantially neutral ammonium salt can be provided as an aqueous solution having monoammonium and diammonium phosphates by reacting an about from sixty to ninety-five, preferably about from seventy to ninety, percent by weight solution of phosphoric acid with an about from fifteen to forty, preferably about from twenty to thirty-three, percent by weight solution of aqueous ammonia in a ratio sufficient to produce a mixture with a substantially neutral pH, say, about from six to seven and a half, preferably about from 6.6 to 7.0. Such a solution may be commercially obtained.

The substantially neutral ammonium phosphate salt is combined with the active hydrogen-containing nitrogenous organic compound, i.e., the spumific; the hydroxyl-containing carbonific; and the mold inhibitor. The combination, or contact, of the components may be carried out in any suitable order. Thus, an initial contact may be salt to spumific to prepare a salt-spumific intermediate, followed by contact with the carbonific; an initial contact may be salt to carbonific to prepare a salt-carbonific intermediate, followed by contact with the spumific; or the spumific and carbonific may be initially mixed, with that mixture contacted with the salt. The mold inhibitor may be added at any suitable stage, and may accompany any suitable component or intermediate. Preferably, however, the mold inhibitor is added to the freshly prepared fire retardant composition made from the substantially neutral ammonium phosphate salt, spumific, and carbonific, especially while the composition is still warm from contact and reaction of the initial components. Other component(s) such as wetting agent(s), defoaming agent(s), and so forth, may also be added at suitable time(s). Preferably, however, when the composition includes such other component(s), these are included in an initial fire retardant composition, and the mold inhibitor is added afterwards, preferably, again, while the initial fire retardant composition is fresh, especially warm. Conditions are those sufficient to form the fire retardant composition with mold inhibitor of the invention.

As the hydrogen-containing nitrogenous organic compound, or spumific, any suitable substance may be employed. Preferably, the spumific is compatible with the other components employed, and further is soluble therewith or with any diluent employed. For instance, urea or a substituted urea may be employed. Preferably, however, the spumific is urea.

As the hydroxyl-containing carbonific, any suitable substance may be employed. Preferably, the carbonific is compatible with the other components employed, and further is soluble therewith or with any diluent employed, especially water. For instance, a polyol, to include a carbohydrate such as a sugar or starch, may be employed. The polyol thus may be a compound such as glycerol, pentaerythritol, dipentaerythritol, tripentaerythritol; a sugar, say, a monosaccharide such as a triose, tetrose, pentose, hexose, heptose, or octose, to include an aldose or a ketose, or a disaccharide, a trisaccharide, a polysaccharide, and so forth; or a starch. The starch, or another specific polyol, may be absent. A combination of polyols may be employed. Thus, for instance, the spumific can include a six-carbon aldose, with which the polysaccharide may be employed.

With such a base fire retardant formulation or any other suitable fire retardant formulation, or precursor part thereof, is provided the insecticide; it may be added during manufacture of the base, or afterwards. Again, a mold inhibitor may be provided, and it may be provided before, during or after provision of the insecticide.

As the insecticide, any suitable insecticide can be employed in the practice of the present invention, alone or in combination with another insecticide. Preferably, the insecticide is soluble or otherwise able to be carried with the remaining ingredients of the invention such as by dispersion, emulsion, and so forth, and preferably does not hinder any solubility or otherwise any capacity for being carried likewise of other ingredients of the composition of the invention, for example, the mold inhibitor. Preferably, too, the insecticide does not alter, at least significantly, other desirable physical characteristic(s) of the composition that would otherwise exist without it such as, for example, pH, viscosity, and so forth. Preferably also, the insecticide is stable in the composition before, i.e., “in the can,” and after application to the substrate, so as to provide for contact with the target invertebrate. An insecticide may be fire retardant or fire accelerative, but, in the latter case, does not accelerate fire to a degree that the overall composition which contains the insecticide cannot be considered to be a fire retardant composition. Preferably, the insecticide, when applied to a suitable substrate in a suitable amount, provides measurable protection to the substrate from the target invertebrate(s). The measurable protection may be tested by a standard protocol. For example, with the substrate wood and the target invertebrate a termite, the protection may be measured by the American Wood-Preservers' Association Standard E1-97 protocol. Be that as it may, the insecticide may be or include inorganic, organic, natural and/or synthetic components, thus perhaps being or including Arsenic, Lead, Mercury, Thallium, or a compound of such, Phosphorus, an organophosphate, Sulfur, an organothio compound, a chlorinated organic compound, a pyrethroid, carbamide, carbimide, cyclopropanecarboxylate, a pyrethrin, and/or a piperonyl ether; examples may include, malathion, parathion, diazinon(0,0-diethyl-0,2-isopropyl-6-methyl(pyrinodine-4-yl)phosphorthioate), permethrin((3-phenoxyphenyl)methyl(+)cis-trans-3-(2,2-dichloroethenyl)-2,2-dimethylcyclopropanecarboxylate) or CAS No. 52645-53-1), resmethrin, d-trans-allethrin, tetramethrin((1-cyclohexene-1,2-dicarboximide)methyl-2,2-dimethyl-3-(2-methylpropenyl)cyclopropanecarboxylate), sumithrin(3-phenoxybenzyl-(1RS,3RS;1RS,3SR)-2,2-dimethyl-3-(2-methylprop-1-enyl)cyclopropanecarboxylate), piperonyl butoxide and butylcarbityl(6-propylpiperonyl) ether, aldrin, chlorodane, dieldrin, endrin, heptachlor, lindane, DDT, DEET, nicotine, rotenone, pyrethrum, azadirachtin, oxalic acid, borax (sodium tetraborate decahydrate), disodium octaborate tetrahydrate, arsenic trioxide, lead arsenate, thallium sulfate, others, and so forth and the like.

Permethrin is a preferred insecticide. It is an effective termiticide, and, among its other benefits, it also may be considered to have termite feeding inhibiting properties. It is available from many sources. For example, it may be found commercially available in “Permanone 40” or “Permanone 90” (Aventis Environmental Science), with concentrations indicated by the numerals, “40” or “90,” which represent the percents by weight of active ingredients in solution.

Any suitable amount of the insecticide may be employed. The amount may be any that is sufficient to kill, control and/or repel a target invertebrate when the composition is applied to, and preferably dried on or in, a substrate. The insecticide may be, independently at each occurrence, say, from 0.01% to 50% by weight of total composition, which includes about from 0.02% to 25%, to include selection of lower and upper values for a range, or sole values, of about 0.1%, 0.5%, 0.75%, 1%, 1.5%, 2%, 2.5%, 3%, 3.5%, 4%, 5%, 7.5% and 10%. Such values may be considered to be approximate or precise. Thus, for instance, the insecticide may be added at about from 0.5% to 10%, about from 0.75% to 1.5%, about from 1% to 3.5%, about from 1% to 5%, about from 2% to 4%, about 1% (which, for example, may include some 0.9%) or about 2% (which, for example, may include some 1.8%) by weight of the base fire retardant formulation or base formulation plus mold inhibitor, in particular, when the insecticide is a termiticide.

As the mold inhibitor, any suitable substance may be employed. Preferably, the mold inhibitor is compatible with the other components employed, and preferably further is soluble therewith or with any diluent employed. For instance, the mold inhibitor may be a quaternary organic ammonium halide, to include a quaternary alkyl ammonium halide, especially such a halide having at least one short chain and at least one medium chain alkyl group, for example, two of each, and an otherwise corresponding quaternary alkyl aromatic ammonium halide. The halide is advantageously a chloride. The short chain alkyl group may be inclusive of, separately at each occurrence, a one- to an about five-carbon group, especially a one- to four-carbon group, for example, a methyl, ethyl, propyl, and so forth group. The medium chain alkyl group may be inclusive of, separately at each occurrence, an about six- to an about thirty-carbon group, especially a six- to an about twenty-carbon group, for example, a hexyl, heptyl, octyl, nonyl, decyl, undecyl, dodecyl group, a thirteen-, fourteen-, fifteen- or sixteen-, seventeen-, eighteen-, nineteen-, or twenty-carbon group, and so forth. Preferably, the short chain alkyl group is methyl and/or ethyl, especially methyl, and the medium chain alkyl group is an eight- to twelve-carbon group, to include a mixture thereof, especially decyl, which can be present as an n-alkyl group. The halide is advantageously a chloride. For example, the mold inhibitor employed may be the mold inhibitor is a fungicide such as didecyldimethylammonium chloride (diDe-diMe-AmCl). An aromatic group, to include an aryl, alkaryl and/or arylalkyl group, for example, a benzyl and/or ethylbenzyl group, may be present, for instance, in a quaternary organic to include a quaternary alkyl aromatic ammonium halide mold inhibitor, for example, an alkyldimethylbenzylammonium chloride (Alk-diMe-Bz-AmCl). The mold inhibitor may be a mixture containing more than one mold inhibitor compound. An increase in concentration of a quaternary ammonium halide mold inhibitor can provide for a corresponding reduction in the amount of an ammonium phosphate or ammonium orthophosphate.

The mold inhibitor is employed in any amount sufficient to provide for kill, control or prevention of growth of the target organism(s), especially when the composition is applied to, and preferably dried on or in, a substrate. It may be employed by weight of the final product in an amount up to about fifteen or twenty percent or more, to include, independently at each occurrence, lower values in specified ranges of about one tenth, about one half, about one, and about two percent, and upper values in specified ranges of about ten, about eight, about five and one half, and about four percent. A preferred amount of the mold inhibitor by weight of the final product, which may be coupled with a lower or an upper value amount as noted above or elsewhere herein to provide another value for a specified range, is generally about three percent.

A wetting agent, or surfactant, may be added. Preferably, any surfactant is biodegradable. Generally, when employed, the surfactant is present in an amount sufficient to effectively release surface tension in the composition and to allow it to effectively and evenly penetrate the substrate before substantial evaporation of a diluent. Any suitable surfactant may be employed. In preferred practice of the present invention, however, since the fungicide may function as a surfactant agent, particularly if it is of the quaternary ammonium salt variety, as are diDe-diMe-AmCl and Alk-diMe-Bz-AmCl, if surfactant activity is desired, it typically is not necessary to provide any additional surfactant. If an added surfactant is desired, the added surfactant may notably be a nonionic alkylpolyglycoside surfactant, which, for instance, may be commercially available, for example, under the mark GLUCOPON (Henkel Corporation). The GLUCOPON surfactants are more readily biodegradable than conventional petroleum-based surfactants, and have been found to be much safer in testing with land and marine animals, while advantageously offering performance comparable to conventional surfactants in the fire retardant compositions of the invention. GLUCOPON surfactants, which were specifically formulated for cleaning product formulation technology, are made from renewable raw materials: glucose from corn, and fatty alcohol from coconut and palm kernel oils. The surfactant is typically supplied as an aqueous solution containing 50% to 70% active matter, having an alkaline pH (11.5-12.5) with no preservative added. Some GLUCOPON surfactants are also available at neutral pH with an anti microbial preservative added. Although perhaps any grade of GLUCOPON surfactant may be used successfully, GLUCOPON-425 may notably be employed as an added surfactant.

A defoaming agent may be added. Any suitable defoaming agent may be used, for instance, a salicylate salt, or a silicon compound. The defoaming agent may be potassium salicylate, which is also known to function as a preservative.

Any suitable amount of a component may be employed. Some typical amounts as percents by weight of generally preferred components effective in the practice of the invention are listed as follows, of which any specified components or characteristics are exemplary and for purposes of illustration, and which listed amounts may be taken as precise or approximate:

| | |
|---|---|
| Mono/diammonium phosphate(s) | 20˜70% |
| Diluent, e.g., solvent, say, water | 25˜50% |
| Spumific, e.g., urea beads | 2.5˜15.0% |
| Sugar, e.g., glucose | 4.0˜12.0% |
| Polysaccharide resin | 2.0˜40.0% |
| Added surfactant, e.g., GLUCOPON-425 | 0.2˜1.2%, |
| | advantageously none |
| Added defoaming agent, e.g., potassium | 0% or 0.01˜0.1% or |
| salicylate in solution | 0.01˜0.5% |
| Mold inhibitor, e.g., diDe-diMe-AmCl | 0% or 0.1˜10%, to |
| | include 0.5˜5.5% |
| Insecticide, e.g., permethrin | 0.1˜5%. |

As a more detailed or preferred formulation to the preferred formula listed above, or as another manner of expressing such, typical amounts as percents by weight (unless otherwise specified or known from context or art) of components effective in the practice of the invention are listed as follows, again, of which any specified components or characteristics are exemplary and for purposes of illustration, and which listed amounts may be taken as precise or approximate:

| | |
|---|---|
| Ammonium orthophosphate | 50˜70% |
| (40% aqueous solution) | |
| Polysaccharide resin, e.g., Lorama LPR76 | 20˜30% |
| (45% aqueous solution) | |
| Sugar, e.g., granulated cane sugar | 5˜10% |
| Spumific, e.g., urea | 5˜7% |
| Added defoaming agent, e.g., potassium | 0% or 0.01˜0.1/0.5% |
| salicylate in solution | |
| Mold inhibitor, e.g., Alk-diMe-Bz-AmCl | 0% or 0.5˜5% |
| (80% aqueous solution) | |
| Termiticide, e.g., as “Permanone 90” | 0.5˜3%. |
| 90% permethrin | |

These ingredients may be stirred until dissolved, making a mixture free of solids and forming a clear liquid with pH, say, about 6.8. However, the mixture may be slightly cloudy or even in some cases more cloudy, or with strata in some cases, yet be effective and appealing.

It is to be understood, however, that many suitable materials may be used as the fire retardant with insecticide, optionally with mold inhibiting or other agent(s), of the present composition. In a preferred embodiment, the fire retardant compound is made from a combination of mono and diammonium phosphate salts formed from reacting about from 75% to 85% solutions of phosphoric acid (H₃PO₄) with aqueous ammonia (NH₄) in sufficient stoichiometric ratios to produce a generally pH neutral solution, and then further reacting the carbon rich material as above and the nitrogen rich urea to form a viscous liquid. To this mixture is added the wetting and defoaming agents mentioned earlier. While this composition is fresh, and still warm, the insecticide and optional mold inhibitor can be added. Each of the starting compounds to make the preferred embodiment is commercially available. The mixture is stirred, again, preferably to dissolve the ingredients and provide a clear solution. As noted above, strata may appear. The mixture is preferably stirred again before application.

As an aqueous solution, the pH of final preferred product can be approximately neutral, for instance, about from five and one half to eight, say, about from six to seven and a half, preferably about from 6 to 7, more preferably and independently at each occurrence about from 6.2 or 6.6 to 6.8 or 6.9. Along these lines, in general, too high a pH, say, above 6.8 or so, may release a discernable ammonia smell with the preferred product, and too low a pH, say, below 6.6 or so, may engender corrosion on certain substrates with which the product comes into contact. The final product may have any suitable density or specific gravity, for instance, about from one to one and a half, say about from one and a tenth to one and a third. The specific density may be about from 1.1 to 1.3. Active fire retardant composition component ingredients, less the insecticide and optional added mold inhibitor present, may be present in any amount, to include about from 40% to 60%, preferably about from 45% to 55%, say, about from 47% to 50%, of the total weight of the fire retardant composition component of the invention. In terms of total weight percent of the final composition, to include the added insecticide and any optional added mold inhibitor, the active ingredients can be present in any effective amount, to include about from 40% to 70%, preferably about from 45% to 55%.

A composition such as NO-BURN® Fire Gard (Fabric Fire Gard) fire retardant spray may be provided with an insecticide. Such is an example of a spray-on liquid of light viscosity and strength, which is an aqueous proprietary product with a formulation that can vary but that can include, in general, such ingredients, with percentages (%) by weight, as follows:

| | |
|---|---|
| Water | 70˜90% to include 76˜82% |
| Phosphorus containing acid, e.g., | 5˜15% to include 10˜12% |
| as polyphosphoric acid (115%) | |
| Ammonium base, e.g., as hydroxide | 5˜15% to include 8˜10% |
| (29% aqueous solution) | |
| Wetting and/or other agent such as | 0.05˜0.2% to include 0.09˜0.13% |
| coco amido-propyl betaine | |
| (30% aqueous solution) | |
| Preservative, e.g., potassium | 0.01˜0.1% to include 0.04˜0.06%. |
| salicylate | |

The present fire retardant composition with insecticide, optionally with mold inhibitor, may penetrate to some degree, which may be a small amount. It may reside substantially on the surface of the substrate. However that may be, preferably, once dried, it leaves a substantially transparent film on the surface of a flammable solid substrate. This results in a composition or residue of the same, which is believed to be relatively safe in application and after drying. Suitable precautions, however, should be undertaken. This results also in a versatile fire retardant composition with insecticide, optionally with mold inhibitor, which can be employed in situations in which the appearance of a substrate such as neutral or stained woodwork is to remain visible, or in which it would be beneficial to retain visual integrity of another substrate. The preferred liquid composition of the present invention is readily absorbed to an extent by porous materials such as wood, fabric, paper, cardboard, and so forth and the like, where it may remain, in essence, indefinitely, if protected from rain and other forms of excess moisture. Advantageously, there is nothing in the preferred formulation of the present invention known to be substantially harmful to wood per se, plywood, or any other wood product in general. Further, since the present composition, notably in its preferred embodiments, is often only applied to the surface, it should not interact with, degrade, or otherwise deteriorate plywood, sheathing, or other types of glued or composite wood products, particularly deep in the substrate.

The present composition may be applied to the materials by any suitable method. The composition, especially in its preferred embodiments, may be applied by spraying, say, by hand-held trigger sprayers, pump-up pressure sprayers, or any other type of manual or automatic power-assisted spraying apparatus, including by power paint rollers (saturated rollers); airless sprayers; brushing; dipping; and so forth. Advantageously, the composition is applied by spraying. Brushing is a simple, effective expedient. These and other application processes are well known in the art and are subject to many variations. The present composition is applied at any suitable concentration or rate to produce a correspondingly treated material.

Among benefits of the composition of the invention, in general, is that, rather than worrying about putting out a fire, it prevents or substantially retards one from burning. If a fire would start, such a composition automatically reacts to the fire by combining with the combustible gases and tars, converting them to carbon char, nitrogen and carbon dioxide, which delays, retards, or extinguishes the source of combustion before the fire takes hold. Its characteristics can also help improve the environment about a structure on fire by eliminating the production of a significant amount, say, up to some 90%, of the smoke and toxic gases produced by a regular fire, which is important because the majority of fire deaths are caused by inhalation of toxic smoke and fumes long before the fire ever gets close to the victims.

Moreover, the insecticide properties are of notable value. For example, termite repellant properties with the composition can help protect structural integrity of a building structure or part(s) thereof to which it is applied, for example, to floor, ceiling or attic joists, sub flooring, flooring, wooden or composite wall, ceiling or roof boards or sheets, and so forth. As well, in a significant way, the health of occupants or visitors can be aided from detrimental effects of mold that otherwise would have been present if a mold inhibitor is also employed.

The following examples further illustrate the invention. Therein, parts and percentages are given by weight, unless otherwise specified.

### EXAMPLE 1

In a clean, appropriately sized mixing tank, the following raw materials were added under constant agitation:

32 gallons (320 lb.) of 49% solution of mono/diammonium phosphate
(a reaction product of 75% to 85% liquid phosphoric acid and
27% ammonia in water at a ratio sufficient to produce a pH of 6.8,
the reaction of which is exothermic, which serves to heat the mixture);

170 grams of potassium salicylate solution in water;

1135 grams GLUCOPON-425 nonionic alkylpolyglycoside surfactant (Henkel Corp.);

32 lb. urea beads (fertilizer grade);

40 lb. glucose.

All these ingredients were stirred until completely dissolved, until the mixture was free of solids and formed a clear liquid with a pH of 6.8 To this mixture, while the solution was still quite warm, was added 132 lb. of JA250-3 polysaccharide resin (Lorama Chemicals, Mississauga, Ontario), which serves to thicken the mixture and contribute solids for the char-forming reaction. While this mixture was still warm, 3% of BARDAC-2280 didecyldimethylammonium chloride mold inhibitor (an aqueous mixture having 80% active component) (Lonza, Inc., Fair Lawn, N.J.) was added and stirred into the mixture using a high sheer mixer. This formed a base fire retardant composition with mold inhibitor. A retained sample of the foregoing composition with mold inhibitor was drawn from the completed batch and was analyzed for specific gravity, pH, and clarity. Specific gravity was 1.256 @ 19C; pH was 6.8, and the sample passed the clarity test, i.e., the liquid was clear to slightly opaque, with no precipitants visible by the naked eye.

Once the foregoing ingredients are adequately and evenly dispersed, a sample of permethrin insecticide/termiticide, say, as “Permanone 90,” can be added under moderate sheer.

The finished product is a liquid (as is the base fire retardant composition with mold inhibitor). It can be pumped to a storage tank for later filling, or filled into proper containers.

### EXAMPLE 2

The base formulation of Example 1 (the base liquid fire retardant composition with mold inhibitor without the insecticide) was applied to the surface of Red Oak tongue and grooved flooring at a rate of 300 square feet per U.S. gallon in two coats, and allowed to dry in a conditioned room at 72 degrees F and 50% relative humidity until the product had dried and reached a constant mass. Once dried to constant mass, the panels were tested under the ASTM E84 procedure, which resulted in a Flame Spread Rating of 35. Untreated flooring from the same batch of lumber was tested under the ASTM E84 procedure to determine the inherent flammability of the panels. The identical but untreated panels had a flame spread rating of 70. This serves to demonstrate the effective fire retardant properties of the base formulation.

The permethrin-containing final composition is expected to test like the base formulation.

### EXAMPLE 3

The base formulation of Example 1 (again, without the insecticide) was applied in a thin layer by brush to the surface of small, uniformly sized pieces of wood, i.e., Douglas Fir plywood and Spruce lumber, and subjected to the ASTM D5590-94 test method, employing the mold species known as Stachybotrys chartarum. After the required duration of the test, the untreated samples were completely covered with mold growth while the treated samples were mold free.

The permethrin-containing final composition is expected to test like the base formulation.

### EXAMPLE 4

A permethrin-containing final composition as of Example 1 can be tested according to the American Wood-Preservers' Association Standard E1-97 protocol, which may be conducted with control(s). The final composition will demonstrate effective termiticide properties.

### EXAMPLE 5

A liquid base formulation was made basically according to Example 1, with a diDe-diMe-AmCl mold inhibitor, except that no surfactant such as the GLUCAPON-425 nor defoamer such as the potassium salicylate was added. An equivalent amount of water replaced the GLUPACON-425. The resultant base formulation intermediate product was most satisfactory.

Once the ingredients of the liquid base formulation are adequately and evenly dispersed, a sample of “Permanone 90” can be added under moderate sheer. The finished liquid product can be pumped to a storage tank for later filling, or filled into proper containers.

### EXAMPLE 6

A commercial base liquid formulation was prepared, generally according to the procedures of Examples 1 and 5. The protocol for the same is generally as follows:
A. An appropriately sized mixing tank is selected and checked for cleanliness. If necessary, it is cleaned using hot water and a detergent solution, and rinsed.
B. Raw materials are weighed and added to a mixing tank, beginning with water.
C. After all raw materials have been added, solution is allowed to mix for 60 minutes or until all solids appear to be dissolved.
D. A retained sample is drawn, and analyzed for specific gravity, pH, and clarity.
   1. If approved by quality control, the product is released to be filled.
   2. If the retained sample fails any of the tests, then corrective measures are implemented, and another retained sample is drawn and tested.
E. Approved finished product is pumped to a storage tank for later filling, or filled into proper containers.

This intermediate base coating formulation had the following ingredients, in general:

| | |
|---|---|
| Ammonium phosphate/orthophosphate | 57.0% |
| (40% aqueous solution) | |
| Lorama LPR76 polysaccharide resin | 24.24% |
| (45% aqueous solution) | |
| Granulated cane sugar | 7.29% |
| Urea | 5.78% |
| Mason CS428* alkyldimethylbenzylammonium | 3.69%. |
| chloride (80% aqueous solution) | |

*Mason CS428 (Mason Chemical Co., Arlington Heights, Ill which contains Alkyldimethylbenzylammonium chloride (C₁₂₋₁₆) (CAS #68424-85-1) (80% by weight); ethanol (CAS #64-17-5) (10% by weight); and water (10% by weight).

This aqueous formulation provides a superior home fire retardant with mold resistance.

Once the ingredients of the liquid base formulation are adequately and evenly dispersed, a sample of insecticide/termiticide, say, permethrin as “Permanone 90” at 2.0% of the total composition, can be added under moderate sheer. The finished liquid product (1.8% permethrin) can be pumped to a storage tank for later filling, or filled into proper containers.

### EXAMPLE 7

Base liquid fire retardant formulations without mold inhibitor can be made by the procedures of Examples 1, 5 and 6, without adding the respective mold inhibitors (didecyldimethylammonium chloride or alkyldimethylbenzylammonium chloride) or by the procedures of Example 1 of U.S. Pat. No. 6,989,113. Once the ingredients of the liquid base formulation are adequately and evenly dispersed, an insecticide/termiticide, say, permethrin at about from 0.1% to 2%, can be added under moderate sheer to provide a finished liquid fire retardant with insecticide of the present invention.

The base fire retardant formulations provide excellent fire retardant properties. See, e.g., Example 2 of the '113 patent. The permethrin-containing final compositions are expected to test comparably with the base formulations, plus to provide properties of an insecticide/termiticide.

### INCORPORATIONS BY REFERENCE

The specifications, in their entireties, of the U.S. Pat. Nos. 6,982,049 and 6,989,113; and of the U.S. patent application Pub. Nos. 2005/0138888 and 2005/0022466 are incorporated herein by reference.

### CONCLUSION TO THE INVENTION

The present invention is thus provided. Various aspect(s), feature(s), step(s), subcombination(s) and/or combination(s) of the invention can be employed with or without reference to other aspect(s), feature(s), step(s), subcombination(s) or combination(s) in its practice, and numerous adaptations and modifications can be effected within its spirit, the literal claim scope of which is particularly pointed out as follows:

What is claimed is:

1. A fire retardant composition comprising a fire retardant agent and an insecticide, wherein the insecticide is present in an amount sufficient to kill, control and/or repel a target invertebrate when the composition is applied to, and optionally dried on or in, a substrate.

2. The composition of claim 1, which includes a phosphate-catalyzed intumescent composition with an acid source, a spumific and a carbonific.

3. The composition of claim 1, which includes a fire suppressing salt.

4. The composition of claim 3, wherein the fire suppressing salt includes an ammonium phosphate containing fire retardant.

5. The composition of claim 4, wherein the ammonium phosphate containing fire retardant includes a mixture of a substantially neutral ammonium phosphate salt in combination with an active hydrogen-containing nitrogenous organic compound, and a hydroxyl-containing carbonific.

6. The composition of claim 5, which initially includes ingredients listed as follows, in general, with percentages by weight, which listed amounts may be taken as precise or approximate:

| | |
|---|---|
| Mono/diammonium phosphate(s) | 20˜70% |
| Water | 25˜50% |
| Spumific | 2.5˜15.0% |
| Sugar | 4.0˜12.0% |
| Polysaccharide resin | 2.0˜40.0% |
| Added surfactant | 1.2% |
| Added defoaming agent | 0˜0.5% |
| Insecticide | 0.1˜5%. |

7. The composition of claim 6, which contains a mold inhibitor of an quaternary organic ammonium halide present in an amount about from 0.5 to 5 percent by weight of total composition.

8. The composition of claim 5, which initially includes ingredients listed as follows, in general, with percentages by weight, which listed amounts may be taken as precise or approximate:

| | |
|---|---|
| Ammonium orthophosphate | 50˜70% |
| (40% aqueous solution) | |
| Polysaccharide resin | 20˜30% |
| Cane sugar | 5˜10% |
| Spumific of urea | 5˜7% |
| Added defoaming agent | 0%˜0.5% |
| Organic insecticide | 0.5˜3%. |

9. The composition of claim 8, which contains a mold inhibitor of a quaternary organic ammonium halide present in an amount about from 0.5 to 5 percent by weight of total composition.

10. The composition of claim 9, wherein the insecticide includes permethrin, and the mold inhibitor includes an alkyldimethylbenzylammonium chloride.

11. The composition of claim 1, which further includes a mold inhibitor provided in an amount that is sufficient to kill, control, or prevent growth of a target mold, mildew, fungus or other flora, when the composition is applied to, and optionally dried on or in, the substrate.

12. The composition of claim 12, wherein the target mold, mildew, fungus or other flora includes Stachybotrys chartarum.

13. The composition of claim 1, wherein the insecticide includes an organothio compound, a chlorinated organic compound, a pyrethroid, a carbamide, a carbimide, a cyclopropanecarboxylate, a pyrethrin, and/or a piperonyl ether.

14. The composition of claim 11, wherein the insecticide includes an organothio compound, a chlorinated organic compound, a pyrethroid, a carbamide, a carbimide, a cyclopropanecarboxylate, a pyrethrin, and/or a piperonyl ether; and the mold inhibitor includes a quaternary alkyl ammonium halide, which includes at least one short chain alkyl group and at least one medium chain alkyl group, wherein the short chain alkyl group is, separately at each occurrence, a one- to an about five-carbon group, and the medium chain alkyl group is, separately at each occurrence, an about six- to an about thirty-carbon group.

15. The composition of claim 1, wherein the insecticide includes a substance selected from the group consisting of malathion, parathion, diazinon(0,0-diethyl-0,2-isopropyl-6-methyl(pyrinodine-4-yl)phosphorthioate), permethrin((3-phenoxyphenyl)methyl(+)cis-trans-3-(2,2-dichloroethenyl)-2,2-dimethylcyclopropanecarboxylate) or CAS No. 52645-53-1), resmethrin, d-trans-allethrin, tetramethrin((1-cyclohexene-1,2-dicarboximide)methyl-2,2-dimethyl-3-(2-methylpropenyl)cyclopropanecarboxylate), sumithrin (3-phenoxybenzyl-(1RS,3RS;1RS,3SR)-2,2-dimethyl-3-(2-methylprop-1-enyl)cyclopropanecarboxylate), piperonyl butoxide and butylcarbityl(6-propylpiperonyl)ether, aldrin, chlorodane, dieldrin, endrin, heptachlor, lindane, DDT, DEET, nicotine, rotenone, pyrethrum, azadirachtin, oxalic acid, borax (sodium tetraborate decahydrate), disodium octaborate tetrahydrate, arsenic trioxide, lead arsenate, thallium sulfate and a combination thereof.

16. The composition of claim 11, wherein the mold inhibitor is present in an amount about from 0.1% to 10% by weight of the total composition, and the insecticide is present in an amount about from 0.1% to 10% by weight of the total composition.

17. The composition of claim 1, wherein the target invertebrate includes an arthropod.

18. The composition of claim 17, wherein the target invertebrate includes a termite.

19. The composition of claim 1, wherein the fire retardant agent is initially a liquid having ingredients with percentages (%) by weight, as follows:

| | |
|---|---|
| Water | 70˜90% |
| Phosphorus containing acid | 5˜15% |
| Ammonium base | 5˜15% |
| Wetting and/or other | 0.05˜0.2% |
| Preservative | 0.01˜0.1%. |

20. In combination, the composition of claim 1, and the substrate on or in which the composition resides.
